(19) United States
(12) Patent Application Publication
(10) Pub. No.: US 2013/0156278 A1
(43) Pub. Date: Jun. 20, 2013

(54) OPTICAL FLOW ACCELERATOR FOR MOTION RECOGNITION AND METHOD THEREOF

(71) Applicant: Electronics and Telecommunications Research Institute, Daejeon (KR)

(72) Inventors: Hyungon KIM, Daejeon (KR); Jun Seok Park, Daejeon (KR)

(73) Assignee: Electronics and Telecommunications Research Institute, Daejeon (KR)

(21) Appl. No.: 13/718,069

(22) Filed: Dec. 18, 2012

(30) Foreign Application Priority Data
Dec. 19, 2011 (KR) 10-2011-0137611

(51) Int. Cl. G06K 9/00

(52) U.S. Cl. CPC G06K 9/00288
USPC 382/118

(57) ABSTRACT

An optical flow accelerator includes a face recognizing unit to recognize a face from a stereo image provided the optical flow accelerator. A depth information calculation unit calculates depth information of the recognized face on a basis of the recognized face. A face tracking unit tracks a size and a shape of the face depending on a movement direction when the recognized face moves. A controller controls generates depth information of the recognized face depending on an optical flow.

### RELATED APPLICATION(S)

This application claims the benefit of Korean Patent Application No. 10-2011-0137611, filed on Dec. 19, 2011, which is hereby incorporated by reference as if fully set forth herein.

### FIELD OF THE INVENTION

The present invention relates to motion recognition, and more particularly, to an optical flow accelerator capable of accelerating the entire speed of a depth information generation system and motion recognition system in generating a depth image of a stereo camera using an optical flow, and a method thereof.

### BACKGROUND OF THE INVENTION

In general, a stereo camera is widely used to obtain depth information by calculating two images obtained from two cameras. In order to obtain depth information by using two images, a method of extracting depth information by using a distance between pixels of the two images has been mainly used, and recently, a method of extracting depth information by applying an optical flow method to two images has been introduced.

In the method of generating depth information by using a movement distance between pixels of two images, an initialization step is set to obtain depth information in an initial stage. During performing the initialization step, great efforts are required for a calibration operation to reduce a distortion phenomenon occurring depending on a camera lens, and the distortion phenomenon due to the camera lens must be handled to obtain relatively minute and accurate depth information.

In comparison to the method of measuring a pixel movement distance, the method of extracting depth information by using an optical flow method between two images may not obtain precise depth information, but with this method, initial setting is simple and a calibration operation is not required for a distortion phenomenon due to a camera lens. Thus, depth information obtained by the optical flow method is mainly used in motion recognition, or the like that does not require accurate depth information.

Meanwhile, in the method of generating depth information based on an optical flow method, when the size of an image is increased to double each time horizontally, the entire pixels are increased to the square of a size thereof, and whenever the entire pixels are increased to the square of the size thereof, a calculation amount of the optical flow existing therein is increased to the square.

Although accurate depth information may not be required for motion recognition, if a target of motion recognition is a human being, as more pixel information is received, more precise motion recognition can be made. Thus, as two sheets of image information obtained from a stereo camera is great, sophisticated motion recognition can be made.

However, as the size of images is increased, the calculation amount of the optical flow method is also significantly increased, having shortcomings that precision is increased but speed is drastically lowered. In actuality, when an image of 320×240 pixels is processed based on the optical flow technique, a processing speed thereof is 30 fps (frame per second). Meanwhile, when an image of 640×480 pixels is processed based on the optical flow technique, a processing speed thereof needs to be substantially 2 fps or lower and should be a quarter speed arithmetically. However, calculation processing is performed at a greatly lower speed than the quarter due to limited system resource.

When depth information is generated at such a low speed, information for motion recognition is insufficient, possibly causing problems that a motion recognition rate is degraded, a motion recognition error occurs, and the like.

### SUMMARY OF THE INVENTION

In view of the above, therefore, the present invention provides an optical flow accelerator capable of performing calculation limitedly on a particular object such as a face or the like whose optical flow method is to be recognized in case of motion recognition in a system generating depth information of a stereo camera using an optical flow, thereby accelerating the entire speed of the depth information generation system and motion recognition system, and a method thereof.

In accordance with an aspect of the present invention, there is provided an optical flow accelerator, which includes: an image input unit configured to input a stereo image; a face recognizing unit configured to recognize a face from the stereo image; a depth information calculation unit configured to calculate depth information of the recognized face on a basis of the recognized face; a face tracking unit configured to track a size and a shape of the face depending on a movement direction when the recognized face moves; and a controller configured to control an operation of the face recognizing unit, the face tracking unit, and the depth information processing unit to generate depth information of the recognized face depending on an optical flow.

Preferably, the controller is configured to erase a background, excluding the recognized face from the input image, and analyze the face movement information based on a partial image without the background to generate depth information depending on an optical flow.

Preferably, the face tracking unit is configured to track the recognized face by frames to track the movement of the face when the recognized face moves. Further, the face recognizing unit is configured to locate the largest face in the input image to recognize a user for face recognition.

Preferably, the depth information processing unit is configured to obtain depth information from the recognized face by using an optical flow technique, and calculate a depth range in which the user corresponding to the recognized face is movable based on the obtained depth information.

Preferably, the depth information processing unit is configured to remove an image having a depth different from that of the calculated depth range from the input image.

In accordance with another aspect of the present invention, there is provided an optical flow acceleration method, which includes: inputting a stereo image; recognizing a face from the stereo image; calculating depth information of the recognized face on a basis of the recognized face; erasing a background having depth information different from the recognized face from the input image based on the depth information to generate a partial image; and analyzing a movement of the recognized face in the partial image to generate the depth information of the recognized face through an optical flow technique.

Preferably, the recognizing a face includes searching for the largest face from the input image to recognize the same as a user for face recognition.

Preferably, the calculating depth information includes: obtaining depth information from the recognized face by using the optical flow technique; and calculating a depth range in which the user corresponding to the recognized face is movable based on the obtained depth information.

### BRIEF DESCRIPTION OF THE DRAWINGS

The above and other objects and features of the present invention will become apparent from the following description of preferred embodiments, given in conjunction with the accompanying drawings, in which:

FIG. 1 is a block diagram of an optical flow accelerator in accordance with an embodiment of the present invention;

FIG. 2 is an exemplary view of two images obtained from a stereo camera in accordance with the embodiment of the present invention;

FIG. 3 is an exemplary view illustrating face recognition in a stereo image in accordance with the embodiment of the present invention;

FIG. 4 is an exemplary view illustrating a total range of depth information obtained from a user recognized by a camera and a range of depth information to be used depending on a motion range of a user, in accordance with the embodiment of the present invention;

FIG. 5 is an exemplary view illustrating an image divided from the entire image in accordance with the embodiment of the present invention;

FIG. 6 is an exemplary view illustrating a movement of a region used in an optical flow scheme depending on a recognized movement of a user in accordance with the embodiment of the present invention;

FIG. 7 is an exemplary view of tracking an image size used depending on a forward/backward movement of a recognized user, rather than a lateral movement of the user in accordance with the embodiment of the present invention;

FIG. 8 is an exemplary view illustrating processing when a recognized user disappears in accordance with the embodiment of the present invention; and

FIG. 9 is a control flowchart illustrating an operation of processing an optical flow of an input stereo image in accordance with the embodiment of the present invention.

### DETAILED DESCRIPTION OF THE EMBODIMENTS

Hereinafter, embodiments of the present invention will be described in detail with the accompanying drawings.

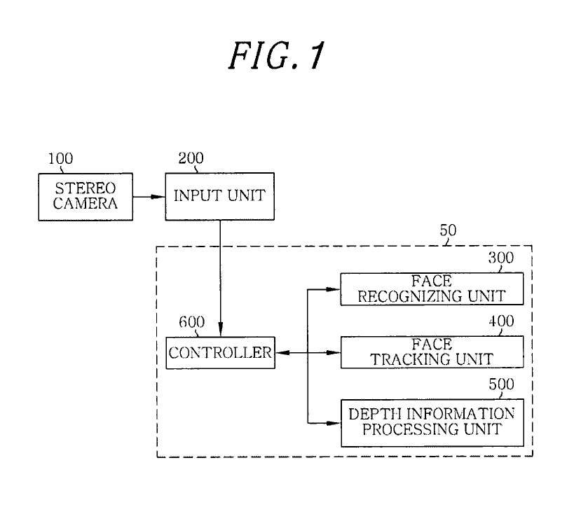

FIG. 1 illustrates a detailed block diagram of an optical flow accelerator 50 using face recognition and depth information in motion recognition in accordance with an embodiment of the present invention. The optical flow accelerator 50 includes a stereo camera 100, an image input unit 200, a face recognizing unit 300, a face tracking unit 400, a depth information processing unit 500, and a controller 600.

The stereo camera 100 includes two cameras each having an optical sensor. Images obtained from the two cameras are transmitted to the image input unit 200 and undergo preprocessing such as noise canceling for image processing.

The optical flow accelerator 50 includes the controller 600, the face recognizing unit 300, the face tracking unit 400, and the depth information processing unit 500, as described above.

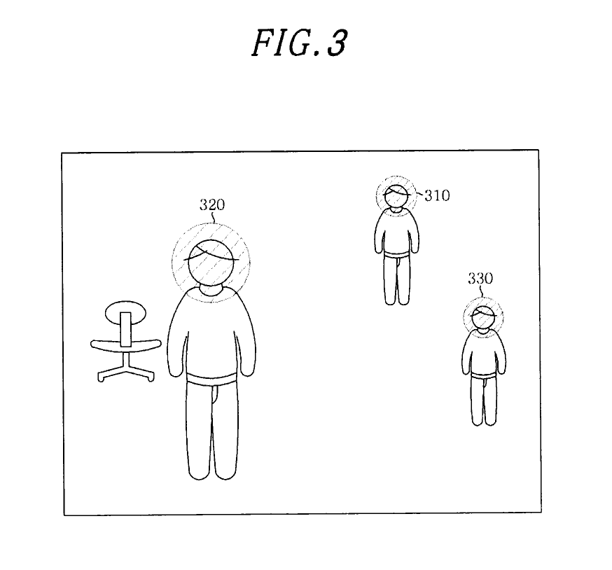

The controller 600 determines whether to process depth information based on an optical flow technique overall by using the two images obtained from the image input unit 200 or whether to cut out only a portion of the images and process the same. Here, the processing conditions are determined based on whether or not a user's face has been recognized. That is, since there is no recognized face in an initial stage, the controller 600 searches for users 310, 320, and 330 from the entire stereo image recognized by the face recognizing unit 300, as shown in FIG. 3.

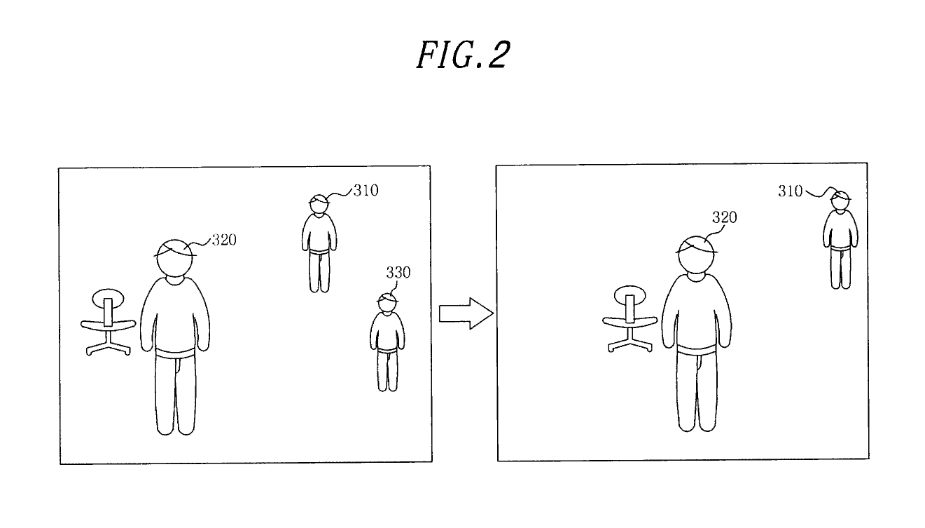

FIG. 2 illustrates two images obtained from the image input unit 200, in which a right image have been moved to the right relative to a left image, depending on the arrangement of the stereo camera 100.

In FIG. 2, there are illustrated three users, and the face recognizing unit 300 locates the largest face and determines the same as the user 320 for face recognition. FIG. 3 illustrates the largest face 320 located among the faces recognized in the images illustrated in FIG. 2.

When humans' faces is searched from the entire images recognized through the face recognizing unit 300, the depth information processing unit 500 obtains depth information of the entire images using an optical flow technique.

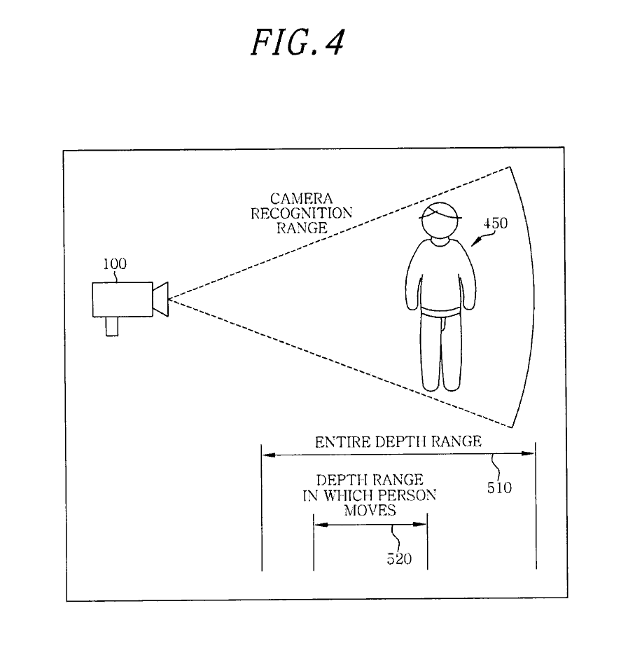

FIG. 4 illustrates a camera recognition range obtained by the stereo camera 100, a range 510 of recognized entire depth information and a depth range 520 in which the recognized person moves.

The depth information processing unit 500 obtains depth information from the face of the recognized person 450, and calculates the depth range 520 in which the recognized person 450 may move based on the acquired depth information. Subsequently, the depth information processing unit 500 removes the remaining depth image portions, excluding the calculated depth range, from the entire depth image. In this case, the depth information processing unit 500 also removes a depth range far away from the recognized face together.

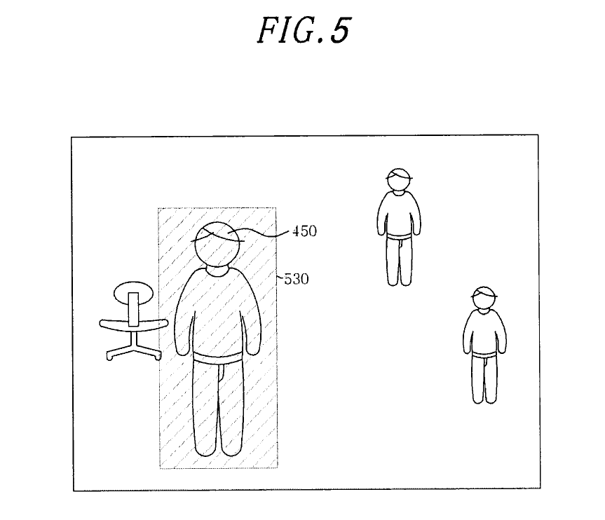

FIG. 5 illustrates a region 530 set to perform depth information processing based on the depth range 520 calculated in FIG. 4.

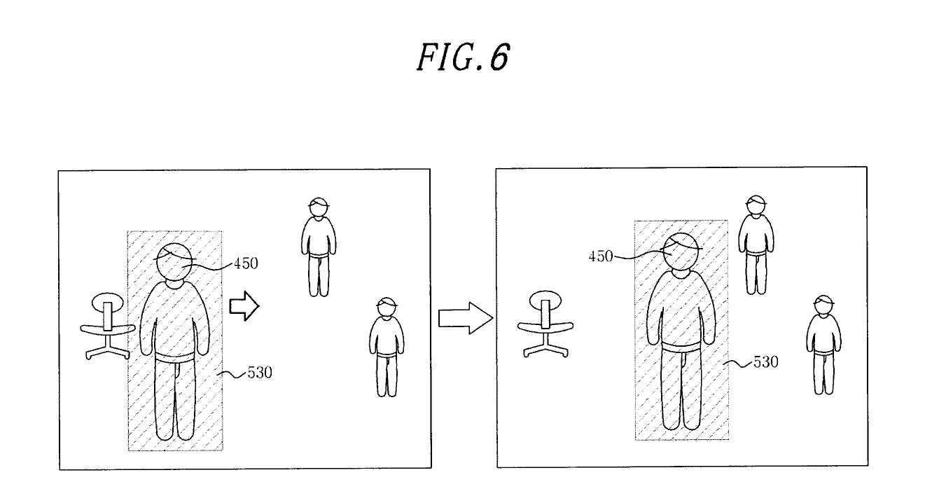

FIG. 6 illustrates a concept of processing the region 530 for the depth information processing in FIG. 5 when the person 450 within the region 530 moves.

As illustrated in FIG. 6, when the recognized person 450 moves in a x-axis direction, the face tracking unit 400 calculates coordinates to which the recognized person 450 has moved, and the calculated coordinates are transmitted again to the depth information processing unit 500 so that the depth information processing unit 500 generates a region movement of the selected region 530 again.

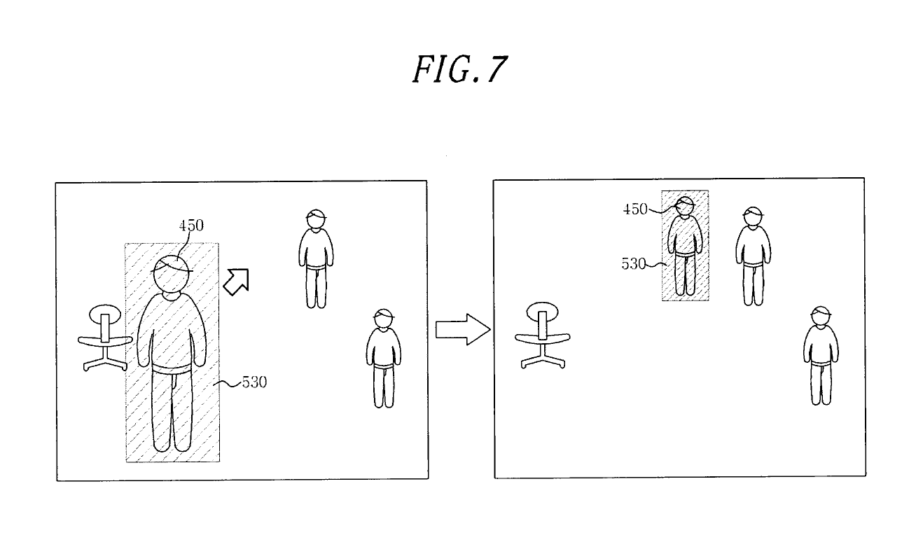

FIG. 7 illustrates a screen in which a recognition region is reduced based on the depth information of the recognized face and the size of the recognized face when the recognized person 450 moves in a z-axis direction.

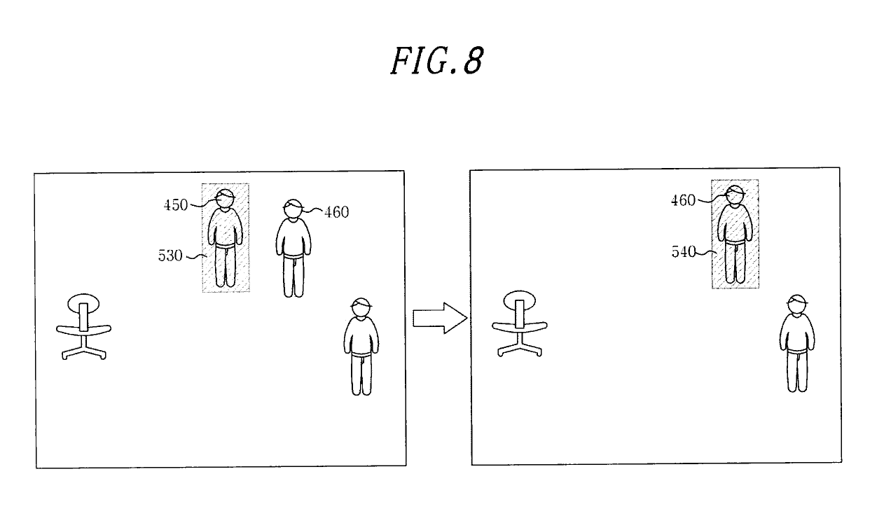

FIG. 8 is a view illustrating a method of processing when the recognized person 450 disappears from the image.

Referring to FIG. 8, when the face tracking unit 400 loses the recognized face, such as when the person 450 disappears from a camera angle or when the face tracking unit 400 cannot recognize the person 450, newly recognizing a face starts again through an initialization process. In FIG. 8, a region 540 is newly selected, and a person 460, who is next to the person 450, is newly recognized in the selected region 540.

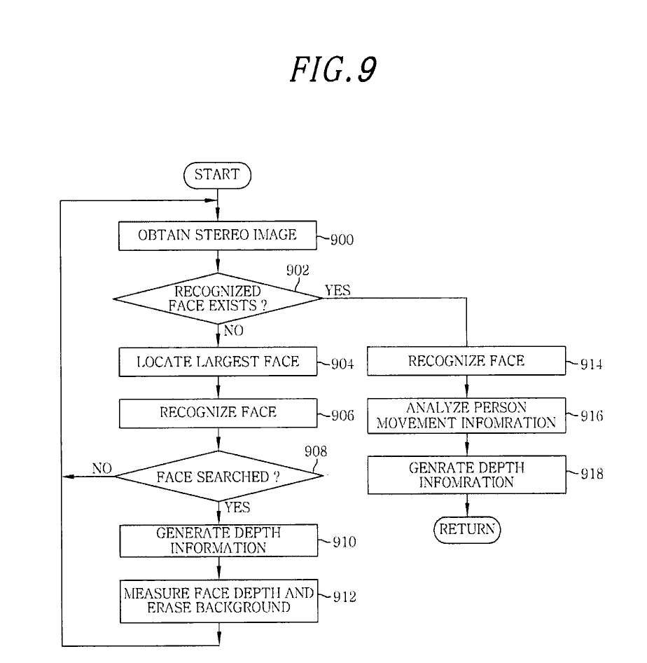

FIG. 9 is a control flowchart illustrating an operation of performing optical flow processing by using face recognition and depth information on an image input from the stereo camera by the optical flow accelerator 50 in accordance with the embodiment of the present invention.

First, the image input unit 200 obtains a stereo image captured from the stereo camera 100 in operation 900 and provides the obtained stereo image to the optical flow accelerator.

Then, the controller 600 of the optical flow accelerator 50 performs face recognition through the face recognizing unit 300, and checks whether or not there is a recognized face from the obtained stereo image in operation 902.

In this case, since there is no recognized face in the obtained stereo image yet, the face recognizing unit 300 performs face recognition by using the entirety of the obtained stereo image in operation 904.

Subsequently, the face recognizing unit 300 locates the largest face in the entirety of the stereo image input from the image input unit 200 and recognizes it as a user, thus recognizing the corresponding user's face in operation 906.

In this manner, when the face is recognized in the entire image through the face recognizing unit 300 in operation 908, the controller 600 generates depth information on the recognized face through the depth information processing unit 500 by using the optical flow technique in operation 910, and erases a background having depth information different from that of the recognized face in operation 912.

That is, the depth information processing unit 500 obtains depth information from the recognized face by using the optical flow technique, calculates a depth range in which the user corresponding to the recognized face may move based on the obtained depth information, and removes an image having a depth different from that of the calculated depth range from the entire image, thus erasing a background.

In this manner, when the partial image obtained by erasing the background from the original stereo image is generated, the controller 600 performs face recognition again on the partial image through the face recognizing unit 300.

The partial image has undergone the face recognition and has a recognized face therein. Therefore, the face recognizing unit 300 performs face recognition by using the partial image in operation 914.

Next, the controller 600 tracks a movement of the recognized face in the partial image in which the face recognized through the face tracking unit 400 exists in operation 916, and generates depth information of the recognized face through the depth information processing unit 500 by using the optical flow technique in operation 918.

In this manner, the optical flow accelerator in accordance with the embodiment of the present invention can reduce an image to be used for an optical flow technique into a portion of the entire image, thus accelerating the overall speed of the system. That is, in case of motion recognition employing the optical flow acceleration technique using the face recognition information and the stereo camera depth information, required depth information can be more quickly obtained. Besides, an error or noise generated by a surrounding object or a surrounding person can be minimized, thus more quickly and accurately performing motion recognition based on depth information.

As described above, in the present invention, in case of motion recognition in the system generating depth information of a stereo camera using an optical flow, an optical flow method is not applied to the entire image desired to be recognized but limitedly to a particular object such as a face desired to be recognized, or the like, and calculation is performed in order to minimize an increase in a calculation amount caused by an increase in the size of an image obtained from the stereo camera, thus accelerating the entire speed of the depth information generation system and the motion recognition system. In addition, in case of motion recognition, since only a surrounding image of a recognized person in the entire image is used, a person and a background can be separated, and thus, motion recognition not affected by the background, or the like can be usefully calculated even during post-processing.

While the invention has been shown and described with respect to the embodiments, the present invention is not limited thereto. It will be understood by those skilled in the art that various changes and modifications may be made without departing from the scope of the invention as defined in the following claims.

What is claimed is:

1. An optical flow accelerator, comprising:
an image input unit configured to input a stereo image;
a face recognizing unit configured to recognize a face from the stereo image;
a depth information calculation unit configured to calculate depth information of the recognized face on a basis of the recognized face;
a face tracking unit configured to track a size and a shape of the face depending on a movement direction when the recognized face moves; and
a controller configured to control an operation of the face recognizing unit, the face tracking unit, and the depth information processing unit to generate depth information of the recognized face depending on an optical flow.

2. The optical flow accelerator of claim 1, wherein the controller is configured to erase a background, excluding the recognized face from the input image, and analyze the face movement information based on a partial image without the background to generate depth information depending on an optical flow.

3. The optical flow accelerator of claim 1, wherein the face tracking unit is configured to track the recognized face by frames to track the movement of the face when the recognized face moves.

4. The optical flow accelerator of claim 1, wherein the face recognizing unit is configured to locate the largest face in the input image to recognize a user for face recognition.

5. The optical flow accelerator of claim 1, wherein the depth information processing unit is configured to obtain depth information from the recognized face by using an optical flow technique, and calculate a depth range in which the user corresponding to the recognized face is movable based on the obtained depth information.

6. The optical flow accelerator of claim 5, wherein the depth information processing unit is configured to remove an image having a depth different from that of the calculated depth range from the input image.

7. An optical flow acceleration method, the method comprising:
inputting a stereo image;
recognizing a face from the stereo image;
calculating depth information of the recognized face on a basis of the recognized face;
erasing a background having depth information different from the recognized face from the input image based on the depth information to generate a partial image; and
analyzing a movement of the recognized face in the partial image to generate the depth information of the recognized face through an optical flow technique.

8. The method of claim 7, wherein said recognizing a face comprises searching for the largest face from the input image to recognize the same as a user for face recognition.

9. The method of claim 7, wherein said calculating depth information comprises:
obtaining depth information from the recognized face by using the optical flow technique; and
calculating a depth range in which the user corresponding to the recognized face is movable based on the obtained depth information.
